(19) United States
(12) Patent Application Publication
(10) Pub. No.: US 2006/0041879 A1
(43) Pub. Date: Feb. 23, 2006

(54) System and method for changing defined user interface elements in a previously compiled program

(76) Inventors: Shelley K. Bower, Fort Collins, CO (US); Allen J. Miller, Fort Collins, CO (US); Michael W. Roberts, Fort Collins, CO (US); Julie B. Wilson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/923,192

(22) Filed: Aug. 19, 2004

(51) Int. Cl. G06F 9/44

(52) U.S. Cl. 717/162; 717/165

(57) ABSTRACT

A system and method is provided for changing defined user interface elements in a previously compiled program using a user interface description file without modifying the compiled program. The method includes the operation of loading the user interface description file from a storage location accessible to the compiled program. The user interface description file can contain user interface definitions and is not linked into the compiled program. The user interface description file can also be parsed to enable the user interface description file to be sent to a configurable filter in communication with the compiled program. A further operation is validating the user interface description file using the configurable filter. An additional operation is defining the compiled program's user interfaces and the interaction between the user interfaces, the compiled program, and data structures for the compiled program based on the user interface description file.

### FIELD OF THE INVENTION

The present invention relates generally to changing defined user interface elements in a previously compiled program.

### BACKGROUND

A computer software program for a specific hardware platform is generally created by compiling source code written by a software developer into the native assembly language for the hardware. A program's data structures, functionality, and user interfaces are generally embodied in the source code. In addition, the program's interfaces with other programs or the operating system are represented in the source code.

The compiling process creates a loadable executable or multiple executable files that can be used by a computer hardware platform or host processor. However, it is possible to supply a program that is not in a compiled format using run-time interpretation. Unfortunately, interpreted languages and programs are relatively slow and are not generally used for applications of any significant complexity or for programs that desire any reasonable amount of speed on a given hardware platform. In order to create a much faster program for a hardware system, software developers can compile the source code to create an executable image.

A draw back to compiling programs is that when any change desired in the program is made to the source code by a software developer, then the source code is recompiled. The resulting object code is a fixed image unless the software developer recompiles the program again to regenerate the object code files. Whether the desired change to the software is large or small, the source code is modified to reflect the change, and then the entire application or executable module is recompiled to change the program's object code.

If changes need to be made to the program's user interfaces, data structures, or data formats, then changes are made to the source code and the program is recompiled. When changing data formats for a program, the software developer can reflect these changes in a number places. The first place a change can be made is in the program source code to allow the program to read, store, manipulate, and output data in the format specified by the software developer. The second place a change can be made is in the data file or database where the actual data is persistently stored. If a program data format, data file, or database changes and the inter-dependent part of the program such as a database, or data file does not change, then the program is likely to fail because the program is not able to access the data in the expected format. Another place changes may need to be made is in the user interface source code that accesses, displays and enables manipulation of the data. When the data structure changes then the user interface can be reprogrammed so that user interface can properly interact with the data. Each time changes are made, the program is recompiled in order to take advantage of the changes.

Not only does recompilation take place when the changes are made to the application or the user interface, but the recompilation is generally performed by an expert software developer who is familiar with the tools for creating the application. Source code changes are preferably performed by someone who knows the program, user interface conventions, data structure details, and rules for the data. In addition, any recompilation is time consuming and may take a few hours or days to provide the appropriate recompilation for an object code image.

Some programs interface with a database that provides for the dynamic entry and removal of data. Even with a database interface, the program must generally be recompiled if there is a change to the database. Any change to database tables that a program accesses will translate into source code changes that are eventually reflected in the compiled program.

A compiled program typically has a fixed set of data structures that are coded into the application and the data structures can store specific types of data. Data is frequently loaded from a file, database, or some similar storage location into a program that is executing. Sometimes program data will come from another program or the operating system. Most frequently, program data is stored on a nonvolatile storage medium regardless of the data source. Each time a program executes, the data can be loaded and manipulated. The data may also be saved, printed, or other functions can be performed by a user.

If multiple code modules are generated during the compilation process, the program will have the references between these multiple modules resolved at linking time. Linking is a process where multiple modules are combined together and any data or code references between those code modules are resolved. Regardless of the object code organization, the data structures, user interfaces, and program operations are fixed in an application at compile time and the references between separate modules are linked together.

It may appear that some programs can have changes made to them without recompiling the program. For example, many programs have configuration settings to control a pre-defined part of the program behavior based on a user's options, settings, or preferences. These configuration settings control some behavior in a program, but they are similar to switches that can be turned on or off. A user can change the setting of the software switch in order to enable or disable a function but such configuration flags cannot generally change the program's data formats, user interfaces, or behavior. In other words, the program operations are fixed but a user can activate different functions or displays based on the user's preference. All the user interfaces, functionality, and data structures for the configuration changes are hard-coded in the application even though certain settings can vary the operations actually activated at run time.

An application configuration file may include user interface settings that can load pre-defined configurations. An example of this is Microsoft Word, which allows a user to re-arrange and save toolbar button organization. Despite the fact that the configuration settings can rearrange the buttons in the application, the user interface controls (i.e. buttons) and the data format read by the program are fixed. The user interface, data structures, or attributes cannot really be modified for the application without recompiling the entire application.

The behavior of a program in relation to its own user interfaces and data structures is not trivial. This is because defined user interfaces and data structures correlate directly to the program operation and vice versa. In other words, the program maintenance for user interfaces, program functions, data structures, and validation rules is tied together at a fundamental level in the source code. For example, when a data structure is declared in source code, the corresponding user interface source code is written to manipulate that detailed data structure in the appropriate manner. If the source code and final object code do not know the details of the data structure at compile-time, then the program is likely to terminate abnormally (i.e., crash) or produce undesirable output.

### SUMMARY OF THE INVENTION

The invention includes a system and method for changing defined user interface elements in a previously compiled program using a user interface description file without modifying the compiled program. The method includes the operation of loading the user interface description file from a storage location accessible to the compiled program. The user interface description file can contain user interface definitions and is not linked into the compiled program. The user interface description file can also be parsed to enable the user interface description file to be sent to a configurable filter in communication with the compiled program. A further operation is validating the user interface description file using the configurable filter. An additional operation is defining the compiled program's user interfaces and the interaction between the user interfaces, the compiled program, and data structures for the compiled program based on the user interface description file.

### BRIEF DESCRIPTION OF THE DRAWINGS

FIG. 1 is a flowchart illustrating an embodiment of a method for changing user interfaces in a previously compiled program using a user interface description file without modifying the compiled program;

FIG. 2 is block diagram depicting an embodiment of a system for changing user interface objects, validation rules, and help data in a previously compiled program using a user interface description file, without modifying the compiled program;

FIG. 3 illustrates a window in a compiled program with graphical user interface objects in an embodiment of the present invention;

FIG. 4 is flow chart illustrating an embodiment of a method of delivering software objects in a computing environment using a compiled software manager with user interface objects and validation rules that can be modified without re-compiling the software manager;

FIG. 5 is block diagram illustrating an embodiment of a system for delivering software objects in a computing environment using a compiled program with user interfaces and validation rules that can be modified without re-compiling the compiled program; and

FIG. 6 is a block diagram illustrating an embodiment of system for delivering software objects in a computing environment using a compiled program with user interface objects and data structures using a configurable input interpreter.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Modifying a computer software program that has been compiled can generally be performed by making changes to the program's source code and recompiling the program. Recompiling a program in order to modify certain aspects of the program after the program has originally been completed is time consuming and involves the services of a skilled software developer.

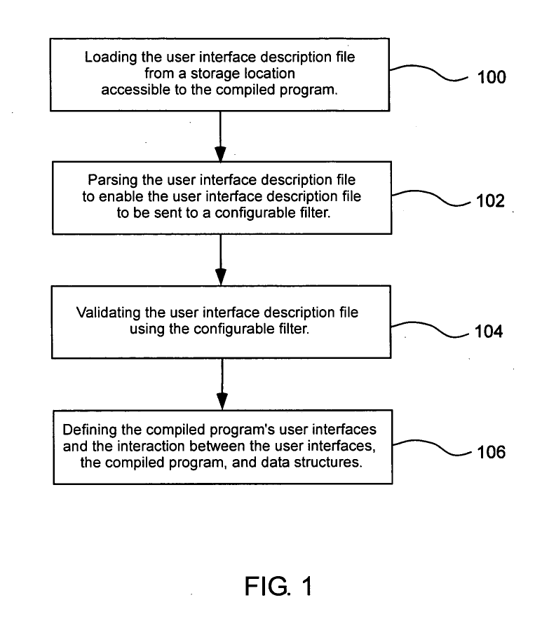

The present invention includes an embodiment of a system and method for dynamically changing user interfaces in a previously compiled program without recompiling the program as illustrated in FIG. 1. These modifications are performed using a user interface description file that aids in changing the user interfaces and their interaction between the compiled program and data structures without modifying the compiled program. The method includes the operation of loading a user interface description file from a storage location that is accessible to the compiled program, as in block 100. The user interface description file can be located in a non-volatile storage location such as a hard disk, CD-ROM, magneto-optical disk, network attached storage device, or some other similar storage system. Alternatively, the user interface description file can be loaded from volatile RAM or requested across the network from another computing node.

The user interface description file can contain the definitions of user interfaces for the program. In addition, the user interface description file is not linked into the compiled program and this is a distinct difference from prior programming practices because user interfaces are typically linked or compiled directly into the compiled program. In the past, this linking has taken place whether the user interfaces were in a separate object code file (e.g., a .DLL file) or were compiled directly into the object code file used as the executable program.

Because the user interface definitions of the present invention are not linked into the compiled program, the user interface definitions can be loaded dynamically by the compiled program. The user interface description file is read using the operation of parsing the user interface description file for a configurable filter associated with the compiled program as in block 102. Parsing identifies the syntactic structure of sentences or strings of symbols in a specified computer language. This language may be in a regular expression language or some other defined language. A parser can take a sequence of tokens generated by a lexical analyzer as input, and a parser may produce some sort of abstract syntax tree as output. The parsing allows the output tokens to be sent to a configurable filter as described.

After parsing, the operation of validating the user interface description file in the configurable filter can be performed as in block 104. The validation operation checks the parsed data structure to ensure that the data meets specific language rules or criteria defined by the specified language the data structure is being created with. The validation rules can also contain user interface rules that are specific to the compiled program.

Not only can the user interface objects be validated dynamically, but the language that the user interface is written and validated in may be provided in a separate file that is loaded into the parser and configurable filter. Being able to change the source language easily provides a more flexible system. Alternatively, the language for creating a user interface can be fixed or hard-coded into the parser and configurable filter. In addition, the user interface description file can be validated based on the language parameters that are stored within the user interface description file.

Once the user interface description file has been validated, then the compiled program's user interfaces can be defined based on the definitions of the user interfaces in the user interface description file as in block 106. In one embodiment, this definition can take place by the instantiation of the user interfaces within the compiled program's allocated data memory by the compiled program or configurable filter. Alternatively, the compiled program can access these dynamically created user interfaces in a separate memory location that may be setup by the configurable filter. When the instantiation of the user interfaces or validation rules takes place, some minimal linking may take place. In one instance, the configurable input filter can send the memory address information of the newly instantiated user interfaces or validation rules to the compiled program. Of course, if the compiled program has instantiated the user interfaces or validation rules after receiving the user interface objects from the configurable filter, then the compiled program can perform its own internal linking.

Not only can the user interface description file include just user interface descriptions, but the description file can also include user interface validation rules and structural definitions for the interfaces with program data structures, and this information can be stored in the user interface description file or a separate file. Validation rules from the user interface description file are used after the user interfaces are defined or instantiated in the program. The validation rules allow the user interface objects or controls to enforce business rules or data rules as the data structures are manipulated. For example, when the end user enters data into a graphic user interface control, then the data entry may include an alphabetic or numeric validation mask. Other validations can also be put in place based on the data structures that are dynamically instantiated into the compiled program. These validation rules can even include triggers that are actions that will be executed when a defined event occurs for the user interface control. Further, the validation rules can supply error messages or other messages to the user of the compiled program.

The validation rules can check enumerated types to determine if data values being entered into the user interface control will be valid for the underlying data structure or check whether the data values are within a specific value range. A defined type rule can be used to check specific data values to see if they match specified business rules. The validation rules can also be used in the compiled program to verify that the data being entered into the user interface controls follows specific defined patterns or regular language expressions. In addition, the validation rules can be used to determine the interdependency of other validation rules. When specific validation rule criteria are met for one rule, then a different validation rule can be applied. More specifically, the validation rules can be used to check if an data being entered into a user interface control has a specific value and determine whether an interdependent validation rule can be applied to check the formatting of information entered into the user interface control in order to determine whether the information can be stored in data structure in the compiled program.

Help data can also be included in the user interface description file. The help information can be tied directly to the user interface objects and validation rules, for which the help descriptions are written to support. This allows the compiled program to load the user interface objects and validation rules and then load the associated help information for each respective user interface component. The modifiable association for help data is important because the user interfaces, data structures, data attributes, and validation rules are being loaded dynamically and can change. The compiled program does not know in advance how the user interfaces need to interact with the data structures or validation rules and thus the help rules must also be modifiable.

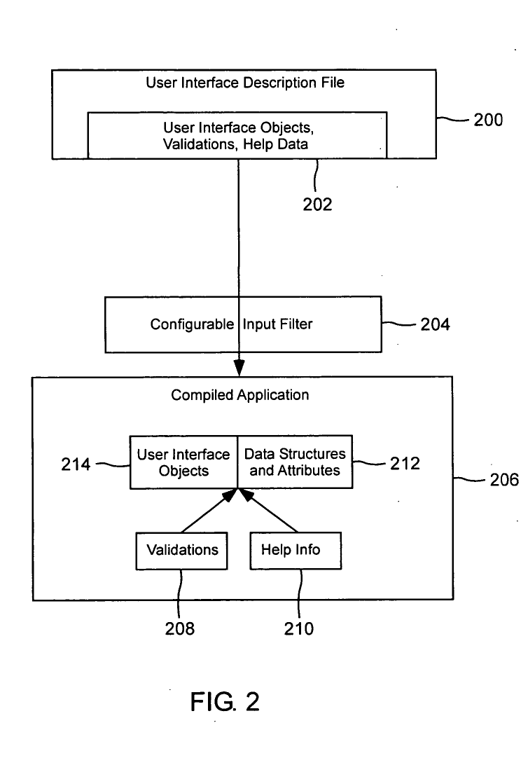

FIG. 2 illustrates a system for changing user interface elements and validation rules in a previously compiled program using a user interface description file. The modification of the user interface objects and validation rules is performed without recompiling the compiled program. The system includes a user interface description file 200 which can contain definitions for user interface objects, validation rules, and help data 202.

A configurable input filter 204 is configured to parse and validate the user interface description file 200 as the user interface description file is read from a storage location. The configurable input filter may include a parser that can recognize a hard-coded syntax or the configurable input filter may load the syntax definition from a separate file. Furthermore, the configurable input filter can be an independent module from the compiled application 206 or a module that is integrated within the compiled application.

The compiled application or program 206 is in communication with the configurable input filter 204. In addition, the compiled program can be configured to instantiate the program's user interfaces and/or validation rules based on the definitions received from the user interface description file 200. The compiled program may know some minimal and/or generic information about the types of user interface that can be instantiated such as a drop-down list box, a Boolean control, multi-line text control, a radio button control, a browse button, a tabbed control, and a tree control, or another type of user interface known to those skilled in the art. This is because the compiled program will be able to understand at least generic types of user interface object that can interface with the data structures in the compiled program. However, the compiled program does not need to know every detail about the user interface object because some of the user interface details can be included in the user interface definition files. For example, the user interface files may include the details required to populate list boxes, control the icons and functions associated with buttons, etc. Alternatively, complete custom controls can be defined and loaded using the user interface description file 200.

The user interface description file can also contain additional information that controls the way in which the underlying data is displayed to end users. Data filtering can also be controlled and this may included input masking and similar features. There may be a filtering of the type of attributes that can entered. For example, there may a limited number data values for attributes and a set of filtering values can be stored in the user interface description file.

Default values for user interface controls can be populated from the user interface description file. For example, default values can be preloaded for data editors such as dropdown lists, file selection boxes, multi-line text edit boxes, single line edit boxes, and similar user interface controls. The user interface control file can also control which data editors are associated with a particular type of data. The validation rules and data masks that are associated with the user interface control can also be provided and modified dynamically. There may also be context sensitive help that is associated with a user interface control and generates errors when data values entered into the user interface control are legal or do not conform to business rules. This help information can be contained in the user interface description file and modified by users as needed. Definitions can also be provided on how to identify to a user that information is invalid. For example, specific sounds, colors or graphical markings can be used to show that an error exists in a specific place in a user interface control.

The user control interface can also include tutorial items and controls that can be modified and loaded dynamically. These tutorial items can include tutorial messages, tutorial controls and tutorial scripts to show examples of functionality in the program.

The compiled program may receive a token or message from the configurable input filter to indicate what general type of user interface is being loaded. This token can enable the compiled program to instantiate the program's user interface objects 214 and validation rules 208 based on the definitions received from the user interface description file as parsed and checked by the configurable input filter. Then the generic user interface object can be modified based on the detailed data received from the user interface definition file as discussed above.

A benefit of this application architecture is that the behavior of the user interface can be changed dramatically without changing the source code and recompiling the entire application. Not only can the user interface that the end user will actually view be changed but the definitions that govern the interaction between the user interface and the underlying data structures and validations can be changed. This means that the graphical user interface can be more easily modified when the underlying program structure changes.

Another element of the present invention is that the user interface description file 200 can also contain information about how the user interface objects may interface with data structures and validations that will be used in the compiled application 206. Specifically, the operations for storing or formatting data entered into the user interface object.

Besides the basic user interfaces and validation rules that are contained in the user interface description file 200, the user interface description file can supply help information 210 that is related to the user interfaces, data structures, attributes, and validations being used by the compiled application. Since the user interfaces and data structures are dynamic, the help information can change for a given version of the user interfaces and/or data structures. Thus, the help information is tied to the user interfaces and may be modified as the user interfaces, data structures, attributes, validations, and other information in the help file change. In addition, help information can be modified as user interface objects and validations are added or removed.

Dynamic attributes and data structures 212 can be included as desired. The attributes for the data structures can include specific details about a data structure, validation, or other objects. Data values can also be stored for attributes. For example, if there is a data structure that is a container named “fileset”, it can have the attribute of a minimum occurrence of one and a maximum occurrence that is limited to one thousand. Thus, the attributes can provide specific data regarding aspects, values, properties, and limitations of an object. In addition, the user interface objects can be loaded from the user interface description file and structured to modify and access the attributes of the data structures. For example, the data structures may be a linked list, a binary tree, a B-tree, a list of records, or another type of data structure known to those skilled in the art. Thus, the user interface associated with the data structure may be modified from the user interface description file to be able to manipulate the underlying data structure and attributes appropriately.

Because the user interface description file is not linked into the program, this design allows the user interface objects, validations, business rules, and help information to be independent from the compiled application. As the program's data structures change or the business rules evolve, the application itself does not have to change. User interface maintenance, data structure maintenance, and validation rule maintenance can be separate and independent activities using the present system and method.

An advantage of separating the described elements from the compiled application is that this separation frees application developers from a significant amount of ongoing application and source code maintenance. Even if the application developers release major revisions periodically, many minor changes can be made to the application data structures, attributes, validation rules, and help data without any intervention from the application developers. This speeds up the application maintenance and saves money. Furthermore, the present invention gives application users the ability to immediately make changes that support the user's specific user interface, data structure, and validation needs.

Another embodiment of the present invention will now be discussed which applies the user interfaces, data structures, and validation rules that are independent from the application. A software distributor may desire to introduce a new data model for a software manager. A software manager can generally include tools or applications for creating install packages and images. However, a software manager is not limited to just these functions and may include other software functions. If the user interfaces and data format for the install package creation application are hard-coded into the application, then the application has to be changed or recompiled in order to support a data model change. In the present invention, the language syntax and grammar rules are configurable and the user interface and data structure can be modified without recompiling the software manager application. Thus, changes to the data model can be made without redistributing a new executable for the application.

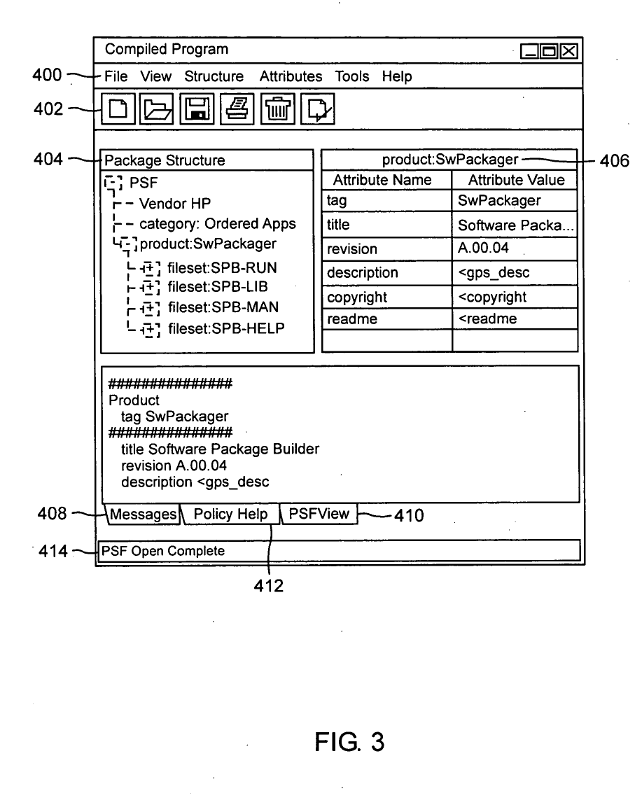

FIG. 3 illustrates a window in the compiled program with graphical user interface objects. A menu bar 400 is depicted with menu items corresponding to actions that can be performed on the data structures and software packages that are being manipulated in the present invention. Particularly, specific menu items can be loaded into the menu bar depending on whether or not the functionality is needed for the underlying data structures and attributes in the compiled program. When a specific menu item is loaded from the user interface description file, functionality corresponding to the menu item may also be loaded from the user interface description file.

The user interface description file can include the descriptions needed for the application tool bar 402. The user interface description file can include information for the functionality, images and ordering of the tool bar items. There may also be information in the user interface description file describing the toolbar button interfaces with the underlying application code and data structures. In other words, the toolbar icons and their operation can be user defined or modified by changing the user interface description file.

A viewing interface 404 can also be provided to view data structures and other underlying information for the application. A view structure for a given data structure can be loaded into the viewing interface. For example a hierarchical data structure can be loaded as described. In the example of FIG. 3, a tree structure is used to view the hierarchical data structure representing a software package. Other viewing structures can be used to view the underlying data structure depending on the viewing structure defined by the user interface description file. As illustrated in FIG. 3, a tree interface can be used to view a hierarchical type of structure. However, there are other viewing structures that can be used to view linked structures such as spreadsheet format, a tabular format, other tree types of data structures, etc. The type of viewing interface that the application will use can be defined in the user interface description file.

In one embodiment, the present invention includes a table interface 406 for viewing the attributes of data structures. This table interface can be used to modify the data contained by attributes for data structures. Alternative user interface styles can also be used to view the attributes. For example, multi-line edit boxes or drop down edit windows can be used. In addition, each attribute value can have a separate user interface editing object associated with the attribute. The attribute user interfaces can include dialog boxes, drop down windows, sliding scales, and other user interface controls. This allows the user interface objects to format, validate and otherwise control the access to the attributes.

A validation message tab 408 can be included to display a list of validation messages for attributes, data structures, or other application objects. The validation message tab illustrates that the graphical user interface can be used to display a tab control or the data can alternatively be displayed in a different form. For example, a scrolling list can be used to display the groups of messages, right clickable menus may display attribute information, or multiple buttons can be used that display pop-up windows. The user interface description file can control the color, font, size, and other details that can be applied by the user interface control. A policy help tab 412 is displayed to show the help messages that are tied to a specific user interface, validation, or data structure. The help messages can be loaded from the user interface description file as discussed previously. In addition, a text view area 410 can be used to display other text, HTML, or XML messages as directed by the user interface description file. A message line output can also be placed at the bottom of the application 414 and the messages and formats of the messages can be configured from the user interface description file.

Another example of the validations that can be controlled by the user interface description file relates to the errors that can occur between different user interface objects. For example, an attribute element may be able to be cut and pasted into a first attribute type but not pasted into a second attribute type. In addition, there may be parts of a hierarchical list that can be copied from one part of the data structure to certain parts of the data structure but not others. These interactions can be defined and stored by the user interface description file and errors can be flagged based on what has been predefined. Then when the user interfaces change or the underlying data structures change, this cross-checking information can be quickly changed in the user interface description file without recompiling the invention.

Another benefit of the present invention provides more cross platform independence. For example, the application can be compiled for two different operating systems but the overall graphical user interface structure is the same, then the same user interface description file can be distributed with both operating system versions of the application. Any later changes made to the user interface description file can be redistributed but just one set of user interface description files will need to be created and distributed. So, not only can compilation be avoided, but a change to one underlying user interface description file can make changes to the user interfaces in more than one operating system version of the compiled application.

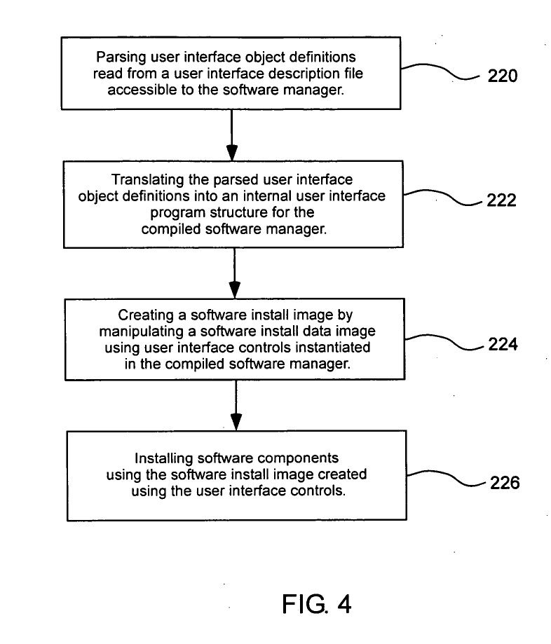

FIG. 4 is a flow chart illustrating a method for this embodiment of the present invention. A method is provided for delivering software objects in a computing environment using a compiled software manager with user interface controls that can be modified without recompiling the software manager. The method includes the operation of parsing user interface object definitions read from a user interface description file as in block 220. This file can be stored in a storage location that is accessible to the software manager. As mentioned before, the user interface description file can be stored on a nonvolatile storage medium such as a hard drive, optical disk, CD, a network attached storage, or some similar nonvolatile storage medium. Alternatively, the file can be read from a memory location where it has been loaded by a host computer. For example, this file can reside in RAM, Flash RAM or a similar type of ROM or RAM.

Another operation is translating the parsed user interface object definitions into an internal user interface program structure for the compiled software manager as in block 222. For example, the user interface objects can control access to a data structure that represents an installable software application which has multiple files contained within the install image. In addition, the user interface structure can be used with data structures and validation rules that represent packages containing suites of software applications as defined by the compiled software manager. The user interface objects can be changed at application load time to manipulate and view the same data structure in different ways. An example of this is where the underlying data structure includes a hierarchical pointer structure. As a result, the data structure can be viewed in a tree style view, a spreadsheet view, or a tab-based view with the tabs and sub-tabs representing levels in the hierarchy.

A further operation is creating a software install package or image using the compiled software manager as in block 224. The software install package can have user interface controls supplied by the user interface description file and the user interface controls can interact with the data structures and validation rules. The software install package may include one or more compressed files that makeup a group of software objects, data files, packages, application suites, bundles, or similar software that can be installed into a computing environment. A final software install package or image is loadable and executable so that the operating system can run the install image and install the appropriate files and components as organized by the software manager. A further operation is installing software components into the computing environment using the software install package created as in block 226.

The user interface description file helps to enable the incorporation of additional software components into a software install image that can be installed into the computing environment or operating system. By including additional user interface objects in the user interface description file, the user interface for creating the software install package can be modified. For example, defined key words can be added to the user interface description file. Defined key words may represent certain user interfaces that can be used in generating in the application install image. Applications a user wants to install may contain multiple files, multiple products, or software bundles within the software install image. For example, the user interface key words can signal the input filter to instantiate a tree user interface to aid in defining a software package.

The present invention enables an end user or developer of a software install package to edit the user interface description file in order to add, remove, or change defined key words for user interface objects and their associated validation rules. The changes to the key words can change the user interface used to generate the install image using the compiled software manager. In addition, the defined key words can control the interface between the user interface controls and the data structures. In other words, the defined keywords and syntax can define how the user interface controls communication with the data structures or writing data to the data structures. Editing can be performed on the user interface description file using a text editor if desired. Alternatively, a graphical user interface utility can be provided to edit the user interface description file.

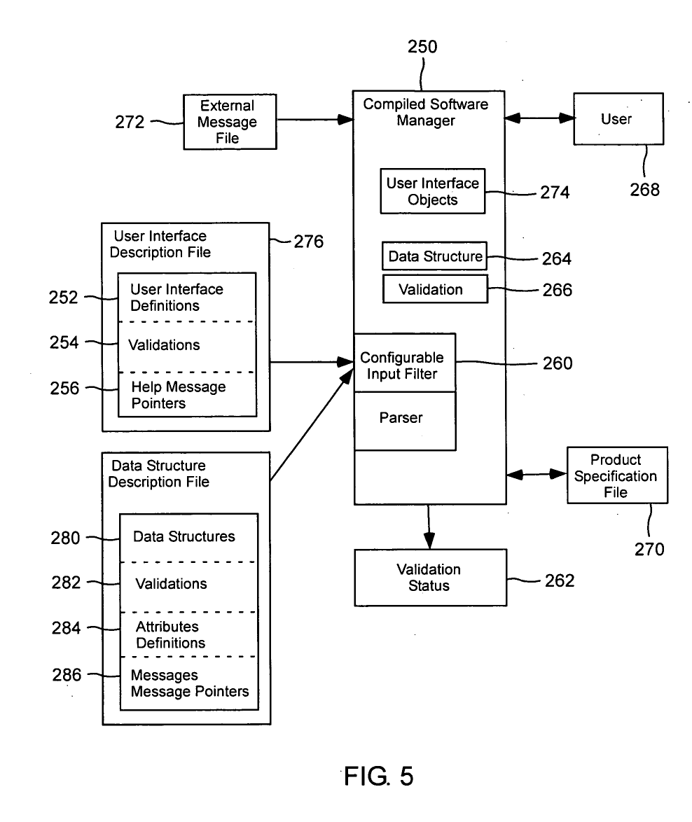

FIG. 5 illustrates a system for delivering software objects in a computing environment or an operating system. The delivery method can include installing a software bundle that contains software objects or files. For example, a suite of applications can be installed onto an operating system. The system comprises a user interface description file 276 that contains definitions for user interfaces 252, validation rules 254, and help message pointers 256. The user interface description files are not linked into the compiled software and are therefore independent from the software manager's source code compilation process. An external message file 272 can be used for storing certain messages.

The help messages or message pointers 256 can be tied to the data structures, attributes, and validations in the description file. Message pointers may also be provided which point to a separate file or some other location (e.g., universal resource locator (URL) ) so that the messages can be loaded from a location outside of the user interface description file.

Some previous software development languages or programs have provided message catalogs that use hard-coded message pointers in the application. In this situation, only the message content can change but not which object, attribute, or validation rule is associated with the message. The present invention allows message pointers or message content to be dynamically associated with different data structures, validation rules, or other dynamic program operations.

In addition, a data structure description file can be included which contains data structures 280 and data structure validations 282. Attributes and definitions 284 can also be included in the description file. As discussed previously, attributes may be defined for keywords, data structures, objects, or variables. The attributes can store values for a keyword or object such as a maximum, a minimum, a string, or an enumerated type for the data structures. However, an attribute is not limited solely to the types described above. Messages and message pointer 286 can also be stored in the data structure description file. The messages can be customized messages for the data structures, validations, or attributes. Because the data structures, validations, or attributes can change, the messages for those items are most useful when the messages can change too.

Referring again to FIG. 5, a configurable input filter 260 is in communication with the compiled software manager 250. The configurable input filter can parse and validate the user interface description file and/or data structure description file as it is read from a storage location. The parsing that takes place can be integrated directly into the configurable input filter or the parser may be a separate module that is in communication with the configurable input filter. Alternatively, the configurable input filter and parser may be located separately from the compiled software manager and configured to communicate filtered output to the compiled software manager.

The compiled software manager 250 receives the validated and parsed output from the configurable input filter 260, and the software manager then can instantiate the user interfaces, data structures, attributes, and validation rules in the compiled software manager. The dynamically created user interfaces and validation rules can then be used as an interface to the data structures to generate the final output of a product specification file 270. This product specification file can be output from the compiled software manager using the user interface objects 274, validation rules 264, program data structures 266, and attributes.

The product specification file 270 can then be used to finally create a software install package for delivery to a user. When the user receives the software install package, the user can load and execute the software install package and the compressed information is uncompressed and installed in the manner defined through the user interface, the program data structures, and validation rules in the compiled software manager.

A particular benefit of the compiled software manager is that it allows a user 268 to create product specification files or software install packages without going through the iterative error correction process that has been performed in the past for creating product specification files. In order for a user to understand how to create a software package specification before the availability of the software manager, the user had to read a detailed manual. Then the user edited the product specification file using a text editor and tried to create an installable software package from the resulting product specification file. Next, the user processed the product specification file and the software to be packaged into a software depot or install image in order to determine whether the product specification file was syntactically correct. If there were errors in the product specification file, then the product specification file would be re-edited by the user who would then re-attempt to create another install image. This trial and error method allowed the user to eventually get enough syntax correct to create a correct image after a significant number of tries.

The process of creating software installation packages has generally been regarded as so complex that few end users have chosen to use the native software install format in some versions of UNIX. Rather, many software developers have simply used compression programs such as “tar” and “ninstall” which do not register the software in the installed product database in the operating system. The present invention overcomes this problem and provides a robust and powerful solution for creating install images.

With the present invention, a user of the software manager can verify that the product specification file is syntactically correct without creating an actual install image. Users receive immediate feedback about their installation project because the software manager limits the user's user interface inputs to legal structures based on the provided user interface limitations in the external user interface description file.

The validation rules 254 can check for the appropriate data structures and data values according to the defined rules and provide a validation status 268. This means that a user 268 can immediately see when an error has been generated or some conflict may exist because a message can be displayed in a window or graphical user interface control. In addition, because the user interface object and validations are customized to match the data structures, this can also prevent the users from generating errors in the product specification file. For example, the only valid input entries for a given type may be pre-populated into a drop down list or radio button. Errors can also be identified using the user interface validation rules 254, or the validations at the data structure level 282 can be output in a window, a drop down list, or some other custom graphical user interface output.

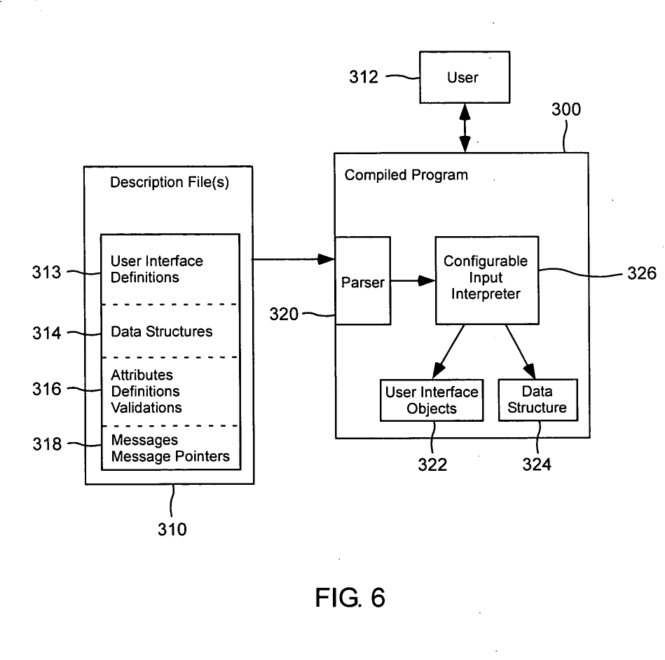

FIG. 6 illustrates an additional embodiment of a system for supplying data structures and validation rules in a previously compiled program using a user interface description file 310 with interpretive loading of the user interface description file. The system includes a user interface description file containing definitions for user interface objects 313, data structures 314, attributes, definitions and validations 316, and messages or message pointers 318. The user interface description file can be loaded by a parser 320 that is configured to parse the user interface description file as it is read from a storage location. This can even occur after the compiled program has been running for a period of time and user interface description file has changed or the user wants to reload the user interface description file.

A configurable input interpreter 326 can be located with or in the compiled program. The parser is in communication with the configurable input interpreter and can send parsed data to the configurable input interpreter. In addition, the configurable input interpreter can be configured to interpret the user interface description file when the compiled program is executing as opposed to initially loading. The previous embodiments discussed are directed generally toward, but are not limited to, loading the user interface description file when the compiled application is loaded for execution. However, in the present embodiment, the configurable input interpreter can load and create new user interface objects 322, data structures 324, attributes, validations and any other information at the request of the user 312 or the compiled program 300. For example, the execution-time loading can be activated by clicking a user interface button in the compiled program or the compiled program can be pre-programmed to load information at specific points during the program's execution.

Not only can the user interface description file be loaded at execution time or run-time but the interpreter may generate additional object code to be used in the user interface or to manipulate the data structures. This object code can be created based on the validations supplied by the description file or object code can be generated based on the types of user interfaces, data structures, attributes, validations and similar structures loaded. In addition, object code can be based on other pseudo source code instructions or explicit source instructions included in the description file.

In another embodiment of the present invention, the system and method can use XML (Extensible Markup Language) files for the user interface description file. XML is a useful format because it provides user interface objects, data structures, and attributes that can be considered self-defining and sub-objects can also be contained within an object. In addition, XML can be used to define objects that are user interface objects, validation rules, business rules, or help messages.

The Document Object Model (DOM) may be used to create an interface for the compiled program and scripts to dynamically access the user interface description file. Particularly, DOM is a platform and language interface that allows programs and scripts to dynamically access and update the content of documents. DOM provides a standard from an international standards committee for the random access of XML data.

In the case of a software manager, changes to an external XML file can control many aspects of the compiled program behavior. Specifically, the XML file can control definitions of the user interface objects or the software package structure and policies for acceptable attribute values. Help can also be included for understanding the software packaging policies as defined by the XML file. The XML file can also control the validation of the package specifications against packaging policies. A user can change anything that the external XML files control without changing the program source code or recompiling the software manager. For example, users can define company specific packaging and installation policies or even extend the software manager to support other packaging formats that were not known when the software manager was originally created.

The present invention provides advantages over past computer software programs because application behavior has generally been hard-coded within the application. Changes to the user interfaces, data formats, and business rules have typically needed source code changes and program recompilation. In contrast, the present invention allows users or developers to significantly change the user interfaces along with the associated data structures and some behavior for an application without changing the source code or recompiling the application. When the data structure design for a program changes, then the XML file can be modified and the application can learn about the new user interfaces, data objects and formats when the program loads the XML description files.

If the business rules which drive the application change, the application itself does not need to be recompiled. Changes to the XML user interface description file can dynamically control many aspects of the application's user interfaces and the software manager or application can load the user interfaces, data structures, and business rules when the program first executes. Moreover, modifiable rules allow users of the application to modify the application's behavior to better support changing user needs. Users have the potential to change anything that the external user interface description file controls.

One result of the improved responsiveness of the software manager is that users receive feedback earlier in the software installation package creation process. Accordingly, generating the installation package is less time consuming and more reliable. Another benefit of the flexible software manager is that users who need to create an installable image do not need the completed software application. The packaging specification can be constructed and validated before the application is ready to be compressed and packaged. This is because the software manager can validate the packaging specification without actually generating an installation package.

Not only do users receive feedback about syntax and grammar but the users also receive feedback right through the configurable user interface about the conformity or non-conformity of software package attributes. Online help policies can be viewed in conjunction with specific objects to provide direct help to the user with respect to creating and correcting software objects. In addition, the validation errors are immediately reported and can be fixed without attempting to create the entire software install package and having that creation fail prematurely.

In contrast, individuals who have used previous software packaging or install solutions have had an extensive knowledge of package specification syntax, rules regarding valid values, and company specific software packaging or installation policies. Problems with syntax and valid data values could not frequently be identified until the software installation file or image was created. Company specific policies were difficult to verify until software tools even further along in the process of creating and testing the package later validated the software installation packages or images.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for changing defined user interface elements in a previously compiled program using a user interface description file without modifying the compiled program, comprising the steps of:
loading the user interface description file from a storage location accessible to the compiled program, wherein the user interface description file includes user interface definitions and is not linked into the compiled program;
parsing the user interface description file to enable the user interface description file to be sent to a configurable filter in communication with the compiled program;
validating the user interface description file using the configurable filter; and
defining the compiled program's user interfaces and the interaction between the user interfaces, data structures and compiled program elements based on the user interface description file.

2. A method as in claim 1, wherein the step of defining the compiled program's user interface further comprises the step of enabling a user to edit the user interface definition file and change formatting for data structures that are passed from the compiled program to the user interface.

3. A method as in claim 1, wherein the step of defining the compiled program's user interfaces further comprises the step of instantiating user interface objects at runtime for an end user of the compiled program based on the user interface description file, wherein the user interface objects allow the end user to edit data structures and attributes of the compiled program.

4. A method as in claim 1, wherein the step of defining the compiled program's user interface further comprises the step of defining a graphical user interface for the end user of the compiled program.

5. A method as in claim 1, wherein the step of defining the compiled program's user interfaces further comprises the step of defining a command line user interface for the end user of the compiled program.

6. A method as in claim 1, wherein the step of validating the user interface description file further comprises the step of validating the user interface description file based on a user interface definition language loaded from the user interface description file.

7. A method for altering a graphical user interface in a previously compiled program using a user interface description file without modifying the compiled program, comprising the steps of:
loading a user interface description file that contains definitions of graphical user interface objects from a storage location accessible to the compiled program, wherein the user interface description file is independent of the compiled program; and
parsing the user interface description file into a configurable filter in the compiled program;
validating the user interface description file in the configurable filter; and
defining the compiled program's graphical user interfaces and the interaction between the user interfaces and the compiled program based on the user interface description file.

8. A method as in claim 7, further comprising the step of supplying context sensitive help files related to the graphical user interface objects using help information stored in the user interface description file.

9. A method as in claim 7, further comprising the step of applying validation rules in order to determine that valid graphical user interface objects are loaded from the user interface description file.

10. A method as in claim 7, wherein the step of validating the user interface description file further comprises the step of validating the user interface description file against a configurable filter that includes defined user interface keywords.

11. A system for changing a graphical user interface in a previously compiled program using a user interface description file, without modifying the compiled program, comprising:
a user interface description file containing definitions for user interface objects, wherein the user interface description file is independent of the compiled program;
a configurable input filter enabled to parse and validate the user interface description file as the user interface description file is read from a storage location; and
wherein the compiled program is in communication with the configurable input filter, the compiled program being configured to instantiate the program's user interface objects based on the definitions received from the user interface description file.

12. A system as in claim 11, wherein the user interface objects are user interface controls.

13. A system as in claim 11, wherein the user interface objects are graphical user interface controls associated with a data structure attribute table in the compiled program.

14. A system as in claim 13, wherein the user interface objects are selected from the group consisting of a drop-down list box, a Boolean control, multi-line text control, a radio button control, a browse button, a tabbed control, and a tree control.

15. A system as in claim 11, further comprising a validation status module to report a validation status for user interface objects instantiated in the compiled program.

16. A system as in claim 11, further comprising a help system module configured to provide context sensitive help information for the user interface objects.

17. A method of delivering software objects in a computing environment using a compiled software manager with user interface controls that can be modified without re-compiling the software manager, comprising the steps of:
parsing user interface object definitions read from a user interface description file located in a storage location accessible to the software manager;
translating the parsed user interface object definitions into an internal user interface program structure for the compiled software manager; and
creating a software install image by manipulating a software install data image using user interface controls instantiated in the compiled software manager.

18. A method as in claim 17, further comprising the step of installing software components to the computing environment using the software install image created using the user interface controls.

19. A method as in claim 17, further comprising the step of enabling additional software components to be incorporated into the software install image by using the user interface controls from the user interface description file to add data structure elements into the software install image.

20. A method as in claim 17, further comprising the step of using defined user interface keywords in the user interface description file.

21. A method as in claim 17, further comprising the step of editing the user interface description file using a text editor to change the user interface object definitions in the user interface description file.

22. A method as in claim 17, further comprising the step of editing the user interface description file using a text editor to change user interface validation rules and keywords in the user interface description file.

23. A method as in claim 17, further comprising the step of including help information related to the user interface rules in a separate help file.

24. A system for delivering software objects in a computing environment using a compiled software manager with user interface controls that can be modified without re-compiling the software manager, comprising:
a parsing means for parsing user interface object definitions read from a user interface description file located in a storage location accessible to the software manager;
a translation means for translating the parsed user interface object definitions into an internal user interface program structure for the compiled software manager using defined user interface keywords in the user interface description file; and
a generation means for creating a software install image by manipulating a software install data image using user interface controls instantiated in the compiled software manager, wherein the software install image can install a software package.

25. An article of manufacture, comprising: a computer usable medium having computer readable program code embodied therein for changing defined user interface elements in a previously compiled program using a user interface description file without modifying the compiled program, the computer readable program code in the article of manufacture comprising:
computer readable program code configured to load the user interface description file from a storage location accessible to the compiled program, wherein the user interface description file contains user interface definitions and is not linked into the compiled program;
computer readable program code configured to parse the user interface description file to enable the user interface description file to be sent to a configurable filter in communication with the compiled program;
computer readable program code configured to validate the user interface description file using the configurable filter; and
computer readable program code configured to define the compiled program's user interfaces and the interaction between the user interfaces, the compiled program, and data structures for the compiled program based on the user interface description file.
